(19) United States
(12) Patent Application Publication
(10) Pub. No.: US 2022/0208791 A1
(43) Pub. Date: Jun. 30, 2022

(54) METHOD FOR DESIGNING AN ARRAY SUBSTRATE, ARRAY SUBSTRATE, DISPLAY PANEL AND DISPLAY DEVICE

(71) Applicant: SEEYA OPTRONICS CO., LTD., Shanghai (CN)

(72) Inventors: Jialing Li, Shanghai (CN); Dong Qian, Shanghai (CN); Zhiwei Zhou, Shanghai (CN); Yongcai Shen, Shanghai (CN)

(73) Assignee: SEEYA OPTRONICS CO., LTD., Shanghai (CN)

(21) Appl. No.: 17/477,035

(22) Filed: Sep. 16, 2021

(30) Foreign Application Priority Data
Dec. 28, 2020 (CN) 202011582273.3

(51) Int. Cl. H01L 27/12; H01L 27/32; G06F 30/392

(52) U.S. Cl. CPC H01L 27/124; G06F 30/392; H01L 27/3248; H01L 27/3218

(57) ABSTRACT

Provided are a method for designing an array substrate, an array substrate, a display panel and a display device. The method includes: acquiring at least two subpixel arrangements including a first subpixel arrangement of first subpixels and a second subpixel arrangement of second subpixels; determining a minimum common period according to the first subpixel arrangement and the second subpixel arrangement; determining the number of common connection via holes and the number of private connection via holes within the minimum common period according to the minimum common period; and adjusting at least one of a first preset arrangement position and a second preset arrangement position according to the number of common connection via holes and the number of private connection via holes.

### CROSS-REFERENCE TO RELATED APPLICATION(S)

This application claims foreign priority benefits under U.S.C. § 119(a)-(d) or 35 U.S.C. § 365(b) to Chinese Patent Application No. 202011582273.3 filed Dec. 28, 2020, the disclosure of which is incorporated herein by reference in its entirety.

### TECHNICAL FIELD

The present disclosure relates to the field of display technologies and, in particular, to a method for designing an array substrate, an array substrate, a display panel and a display device.

### BACKGROUND

With the development of science and technology and the progress of the society, people are increasingly dependent on information exchange and transfer. As the main medium and material basis for information exchange and transfer, a display device has become a focus of research for many scientists.

Since various via holes in various subpixel arrangements are incompatible, the positions of via holes formed in a previous process are to be modified once a product switches a subpixel arrangement, and even a wafer needs to be redesigned and produced, which increases a material cost and time of production.

### SUMMARY

The present disclosure provides a method for designing an array substrate, an array substrate, a display panel and a display device, so that connection via holes are compatible with at least two subpixel arrangements and when a subpixel arrangement is switched, positions of connection via holes formed in a previous process do not need to be modified and a wafer does not need to be redesigned and produced, thereby reducing a material cost and time of production.

In a first aspect, an embodiment of the present disclosure provides a method for designing an array substrate. The array substrate includes drive circuits electrically connected to subpixels through connection via holes and configured to drive the subpixels to emit light.

The method includes steps described below.

In step S1, acquiring at least two subpixel arrangements; where the at least two subpixel arrangements include a first subpixel arrangement of first subpixels and a second subpixel arrangement of second subpixels, the first subpixel arrangement corresponds to a first preset arrangement position on the array substrate, and the second subpixel arrangement corresponds to a second preset arrangement position on the array substrate.

In step S2, determining a minimum common period according to the first subpixel arrangement and the second subpixel arrangement, where the minimum common period is a minimum period of a subpixel arrangement formed by an overlap of the first subpixel arrangement and the second subpixel arrangement.

In step S3, determining a number of common connection via holes and a number of private connection via holes within the minimum common period according to the minimum common period; and.

In step S4, adjusting at least one of the first preset arrangement position and the second preset arrangement position according to the number of the common connection via holes and the number of the private connection via holes such that a position where each of the common connection via holes is arranged overlaps an arrangement position of a respective first subpixel in the first subpixel arrangement and an arrangement position of a respective second subpixel in the second subpixel arrangement in projection and a position where each of the private connection via holes is arranged overlaps an arrangement position of a respective first subpixel in the first subpixel arrangement or an arrangement position of a respective second subpixel in the second subpixel arrangement in projection.

In a second aspect, an embodiment of the present disclosure provides an array substrate designed and obtained by the method described in the first aspect.

The array substrate includes a substrate, a drive circuit layer disposed on one side of the substrate and a planarization layer disposed on a side of the drive circuit layer facing away from the substrate.

The drive circuit layer includes a plurality of drive circuits.

The planarization layer is provided with the connection via holes, where the connection via holes include at least the common connection via holes.

In a third aspect, an embodiment of the present disclosure provides a display panel. The display panel includes the array substrate described in the second aspect and further includes a plurality of subpixels arranged on one side of the array substrate, where the plurality of subpixels are electrically connected to the drive circuits through the connection via holes.

In a fourth aspect, an embodiment of the present disclosure provides a display device including the display panel described in the third aspect.

The embodiment of the present disclosure provides the method for designing the array substrate. In the method, the first subpixel arrangement and the second subpixel arrangement are acquired, the minimum common period is determined according to the first subpixel arrangement and the second subpixel arrangement, the number of common connection via holes and the number of private connection via holes within the minimum common period are determined according to the minimum common period, and positions of the common connection via holes and positions of the private connection via holes are determined according to the number of common connection via holes and the number of private connection via holes. Therefore, the common connection via holes can be used in both the first subpixel arrangement and the second subpixel arrangement. The connection via holes provided in the embodiment of the present disclosure are compatible with at least two subpixel arrangements. When the subpixel arrangement is switched, the positions of the connection via holes formed in the previous process do not need to be modified, and the wafer does not need to be redesigned and produced, thereby reducing the material cost and the time of production.

### BRIEF DESCRIPTION OF DRAWINGS

FIG. 1 is a schematic diagram of a subpixel arrangement according to an embodiment of the present disclosure;

FIG. 2 is a schematic diagram of another subpixel arrangement according to an embodiment of the present disclosure;

FIG. 3 is a schematic diagram of another subpixel arrangement according to an embodiment of the present disclosure;

FIG. 4 is a flowchart of a method for designing an array substrate according to an embodiment of the present disclosure;

FIG. 5 is a schematic diagram of connection via holes according to an embodiment of the present disclosure;

FIG. 6 is a simplified schematic diagram of the connection via holes shown in FIG. 5;

FIG. 7 is a flowchart of another method for designing an array substrate according to an embodiment of the present disclosure;

FIG. 8 is a flowchart of another method for designing an array substrate according to an embodiment of the present disclosure;

FIG. 9 is a schematic diagram of another connection via holes according to an embodiment of the present disclosure;

FIG. 10 is a flowchart of another method for designing an array substrate according to an embodiment of the present disclosure;

FIG. 11 is a schematic diagram of another connection via holes according to an embodiment of the present disclosure;

FIG. 12 is a schematic diagram of another connection via holes according to an embodiment of the present disclosure;

FIG. 13 is a schematic diagram of another connection via holes according to an embodiment of the present disclosure;

FIG. 14 is a schematic diagram of another connection via holes according to an embodiment of the present disclosure;

FIG. 15 is a schematic diagram of an array substrate according to an embodiment of the present disclosure;

FIG. 16 is a schematic diagram of a display panel according to an embodiment of the present disclosure; and

FIG. 17 is a schematic diagram of a display device according to an embodiment of the present disclosure.

### DETAILED DESCRIPTION

The present disclosure is further described below in detail in conjunction with drawings and embodiments. It is to be understood that the embodiments described herein are merely intended to explain the present disclosure and not to limit the present disclosure. Additionally, it is to be noted that for ease of description, merely part, not all, of the structures related to the present disclosure are illustrated in the drawings.

As used in the present disclosure, a list of items joined by the term “and/or” can mean any combination of the listed items. For example, the phrase “A, B and/or C” can mean A; B; C; A and B; A and C; B and C; or A, B and C. As used in the present disclosure, a list of items joined by the term “at least one of” can mean any combination of the listed terms. For example, the phrases “at least one of A, B and C” can mean A; B; C; A and B; A and C; B and C; or A, B and C.

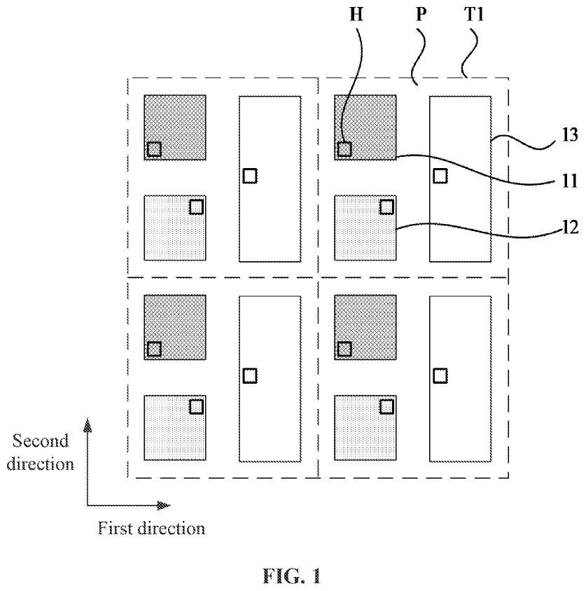

FIG. 1 is a schematic diagram of a subpixel arrangement according to an embodiment of the present disclosure. Referring to FIG. 1, an array substrate includes a plurality of pixel units P, where each of the pixel units P includes a plurality of subpixels which are a first subpixel 11, a second subpixel 12 and a third subpixel 13, respectively, and the first subpixel 11, the second subpixel 12 and the third subpixel 13 are arranged in a delta shape. Along a second direction, the first subpixel 11 and the second subpixel 12 are located in the same column, and the first subpixel 11 and the third subpixel 13 are located in different columns. The array substrate further includes a plurality of connection via holes H that overlap the subpixels. As shown in FIG. 1, a minimum period of first subpixels T1 includes one row and one column of (that is, one) pixel unit P.

Exemplarily, referring to FIG. 1, the first subpixel 11 is a red subpixel, the second subpixel 12 is a green subpixel, and the third subpixel 13 is a blue subpixel, but it is not limited thereto. In another embodiment, for example, the first subpixel 11 may be the green subpixel, the second subpixel 12 may be the blue subpixel, and the third subpixel 13 may be the red subpixel. In another embodiment, for example, the first subpixel 11 may be the blue subpixel, the second subpixel 12 may be the red subpixel, and the third subpixel 13 may be the green subpixel.

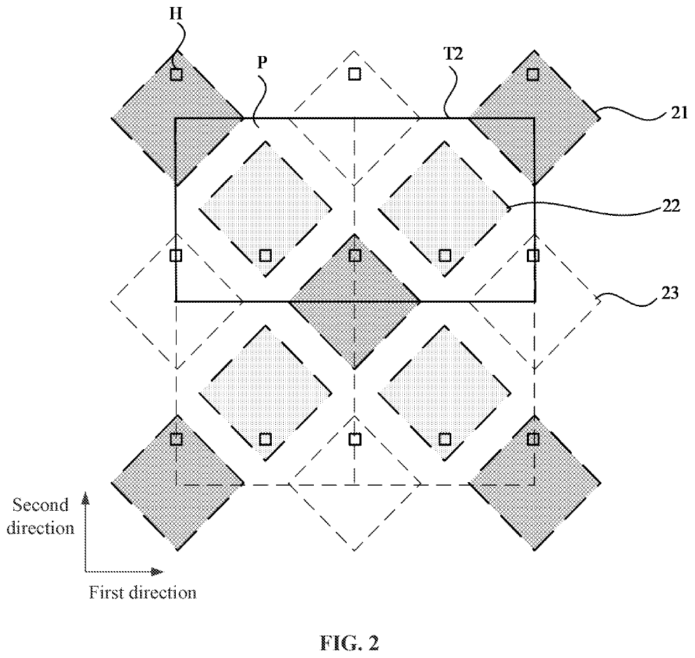

FIG. 2 is a schematic diagram of another subpixel arrangement according to an embodiment of the present disclosure. Referring to FIG. 2, an array substrate includes a fourth subpixel 21, a fifth subpixel 22 and a sixth subpixel 23. Along a first direction, the fourth subpixel 21 and the sixth subpixel 23 are located in the same row and are spaced apart from each other. Along the first direction, a plurality of fifth subpixels 22 are arranged in a row. Along the second direction, the fourth subpixel 21 and the sixth subpixel 23 are located in the same column and are spaced apart from each other. Along the second direction, a plurality of fifth subpixels 22 are arranged in a column. The array substrate further includes a plurality of connection via holes H that overlap the subpixels. As shown in FIG. 2, a minimum period of second subpixels T2 includes one row and two columns of (that is, two) pixel units P.

Exemplarily, referring to FIG. 2, the fourth subpixel 21 is the red subpixel, the fifth subpixel 22 is the green subpixel, and the sixth subpixel 23 is the blue subpixel, but it is not limited thereto.

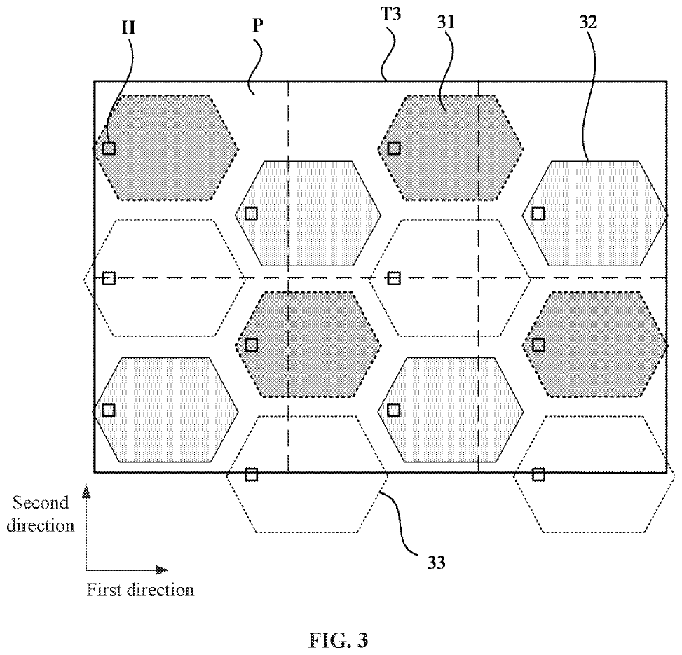

FIG. 3 is a schematic diagram of another subpixel arrangement according to an embodiment of the present disclosure. Referring to FIG. 3, an array substrate includes a seventh subpixel 31, an eighth subpixel 32 and a ninth subpixel 33. The seventh subpixel 31, the eighth subpixel 32 and the ninth subpixel 33 are arranged in a delta shape. Along the second direction, the seventh subpixel 31, the ninth subpixel 33 and the eighth subpixel 32 are arranged in sequence. That is to say, the seventh subpixel 31 is located between the eighth subpixel 32 and the ninth subpixel 33, the eighth subpixel 32 is located between the seventh subpixel 31 and the ninth subpixel 33, and the ninth subpixel 33 is located between the seventh subpixel 31 and the eighth subpixel 32. Two adjacent columns of subpixels are staggered. The array substrate further includes a plurality of connection via holes H that overlap the subpixels. As shown in FIG. 3, a minimum period of third subpixels T3 includes two rows and three columns of (that is, six) pixel units P.

It is to be noted that in other embodiments, any two of the minimum period of the first subpixels T1, the minimum period of the second subpixels T2 and the minimum period of the third subpixels T3 may be interchanged. That is, the minimum period of the first subpixels T1 may also be used for representing the subpixel arrangement shown in FIG. 2 or FIG. 3, the minimum period of the second subpixels T2 may also be used for representing the subpixel arrangement shown in FIG. 1 or FIG. 3, and the minimum period of the third subpixels T3 may also be used for representing the subpixel arrangement shown in FIG. 1 or FIG. 2.

It is to be understood that in the subpixel arrangements shown in FIGS. 1, 2 and 3, positions where the connection via holes H are arranged are related to positions of the subpixels in the subpixel arrangement where the connection via holes H are located. The connection via holes H are arranged at different positions in different subpixel arrangements. Therefore, once a product switches a subpixel arrangement, the positions of connection via holes formed in a previous process need to be modified.

The array substrate may further include drive circuits electrically connected to the subpixels through the connection via holes H and configured to drive the subpixels to emit light.

The drive circuits will be further explained later.

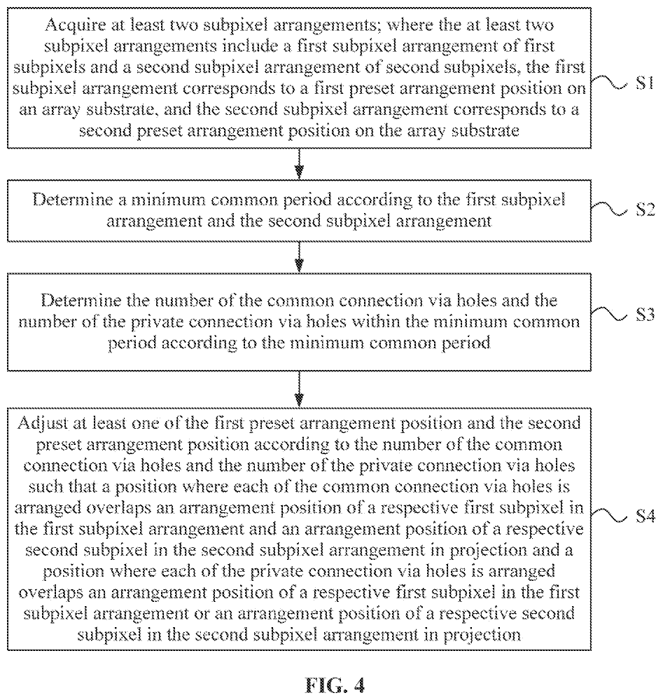

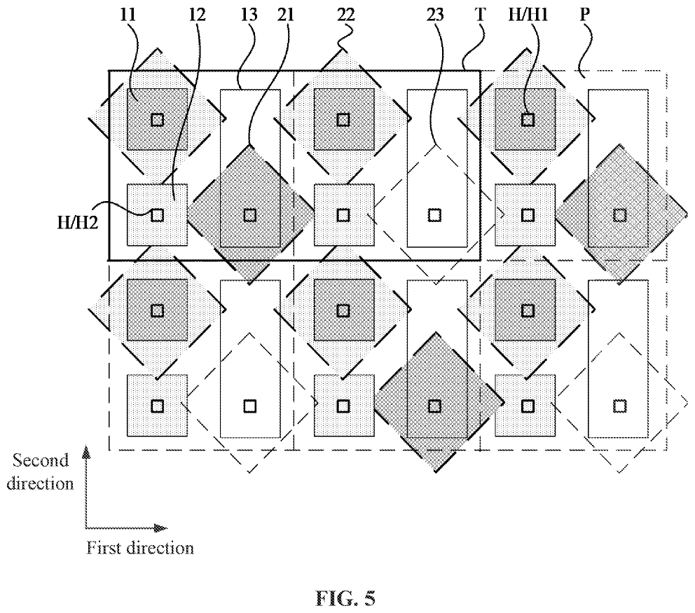

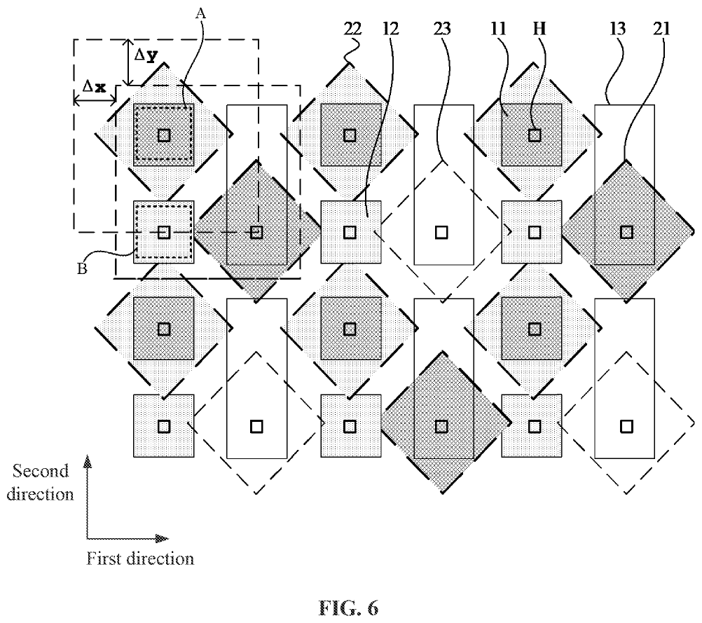

FIG. 4 is a flowchart of a method for designing an array substrate according to an embodiment of the present disclosure. FIG. 5 is a schematic diagram of connection via holes according to an embodiment of the present disclosure. FIG. 6 is a simplified schematic diagram of the connection via holes shown in FIG. 5. A subpixel arrangement shown in FIG. 5 may be regarded as the subpixel arrangement in FIG. 1 overlapped with the subpixel arrangement in FIG. 2, and the connection via holes H are rearranged in the overlapped subpixel arrangement to be compatible with at least two different subpixel arrangements at the same time. Referring to FIGS. 4 to 6, the method for designing the array substrate includes steps described below.

In step S1, acquiring at least two subpixel arrangements; wherein the at least two subpixel arrangements include a first subpixel arrangement of first subpixels and a second subpixel arrangement of second subpixels, the first subpixel arrangement corresponds to a first preset arrangement position on the array substrate, and the second subpixel arrangement corresponds to a second preset arrangement position on the array substrate.

The subpixel is a smallest display unit in the array substrate. The subpixel arrangement may include, for example, a n-type arrangement shown in FIG. 1, a diamond-type arrangement shown in FIG. 2 and a subpixel rendering (SPR)-type arrangement shown in FIG. 3, but it is not limited thereto. The subpixel arrangement may change according to product requirements. For example, the subpixel arrangement may also include a real-type arrangement. The n-type arrangement forms a it-type arrangement pattern as shown in FIG. 1, the diamond-type arrangement forms a diamond-type arrangement pattern as shown in FIG. 2 and the SPR-type arrangement forms SPR-type arrangement pattern as shown in FIG. 3.

Exemplarily, the first subpixel arrangement is the n-type arrangement shown in FIG. 1. The second subpixel arrangement is the diamond-type arrangement shown in FIG. 2.

In step S2, a minimum common period is determined according to the first subpixel arrangement and the second subpixel arrangement, wherein the minimum common period is a minimum period of a subpixel arrangement formed by an overlap of the first subpixel arrangement and the second subpixel arrangement.

Since the first subpixel arrangement and the second subpixel arrangement are both taken into consideration, not only the first subpixel arrangement of the first subpixels but also the second subpixel arrangement of the second subpixels are considered, the firs subpixels and the second subpixels are different layers. It is understandable that when the first subpixel arrangement is overlapped with the second subpixel arrangement, a minimum period in an overlapped subpixel arrangement pattern may change (may be neither the minimum period of the first subpixel arrangement nor the minimum period of the second subpixel arrangement). Alternatively, the minimum period in the overlapped subpixel arrangement pattern does not change may be, for example, the minimum period of the first subpixel arrangement or the minimum period of the second subpixel arrangement. The minimum common period T is the minimum period in the overlapped subpixel arrangement pattern.

In step S3, determining a number of common connection via holes and a number of private connection via holes within the minimum common period according to the minimum common period.

Since the minimum common period T is the minimum period in the overlapped subpixel arrangement pattern, subpixels and connection via holes H are arranged at the same position in every two minimum common periods T. Therefore, the number of the connection via holes H and positions where the connection via holes H are arranged can be determined within the minimum common period T. The connection via holes H include the common connection via holes H1 and the private connection via holes H2. The common connection via hole H1 overlaps at least two subpixels, that is, is a via hole shared by the first subpixel arrangement and the second subpixel arrangement. Connection via holes H except the common connection via holes H1 are the private connection via holes H2. The private connection via hole H2 overlaps one subpixel and is used only in the first subpixel arrangement or the second subpixel arrangement.

In step S4, adjusting at least one of the first preset arrangement position and the second preset arrangement position according to the number of the common connection via holes and the number of the private connection via holes such that a position where each of the common connection via holes is arranged overlaps an arrangement position of a respective first subpixel in the first subpixel arrangement and an arrangement position of a respective second subpixel in the second subpixel arrangement in projection and a position where each of the private connection via holes is arranged overlaps an arrangement position of a respective first subpixel in the first subpixel arrangement or an arrangement position of a respective second subpixel in the second subpixel arrangement in projection.

After the number of the common connection via holes and the number of the private connection via holes are determined in the preceding step S3, positions of the common connection via holes and positions of the private connection via holes are determined according to the number of common connection via holes and the number of private connection via holes in the step S4.

Exemplarily, as shown in FIG. 6, the first preset arrangement position represents a position of the first subpixel arrangement on the array substrate, and the second preset arrangement position represents a position of the second subpixel arrangement on the array substrate. At least one of the first preset arrangement position and the second preset arrangement position may be adjusted such that a first subpixel arrangement pattern moves in whole with respect to a second subpixel arrangement pattern. For example, along the first direction, the first subpixel arrangement pattern moves in whole by Ax with respect to the second subpixel arrangement pattern; and along the second direction, the first subpixel arrangement pattern moves in whole by Ay with respect to the second subpixel arrangement pattern. Ax may be greater than 0, that is, movement in a positive direction of the first direction, or Ax may be less than 0, that is, movement in a negative direction of the first direction. Ay may be greater than 0, that is, movement in a positive direction of the second direction, or Ay may be less than 0, that is, movement in a negative direction of the second direction. However, the embodiment of the present disclosure is not limited thereto.

The embodiment of the present disclosure provides the method for designing the array substrate. In the method, the first subpixel arrangement and the second subpixel arrangement are acquired, the minimum common period T is determined according to the first subpixel arrangement and the second subpixel arrangement, the number of the common connection via holes H1 and the number of the private connection via holes H2 within the minimum common period T are determined according to the minimum common period T, and the positions of the common connection via holes H1 and the positions of the private connection via holes H2 are determined according to the number of the common connection via holes H1 and the number of the private connection via holes H2. Therefore, the common connection via holes H1 can be used in both the first subpixel arrangement and the second subpixel arrangement. The connection via holes H provided in the embodiment of the present disclosure are compatible with at least two subpixel arrangements. When the subpixel arrangement is switched, the positions of the connection via holes formed in the previous process do not need to be modified, and a wafer does not need to be redesigned and produced, thereby reducing a material cost and time of production.

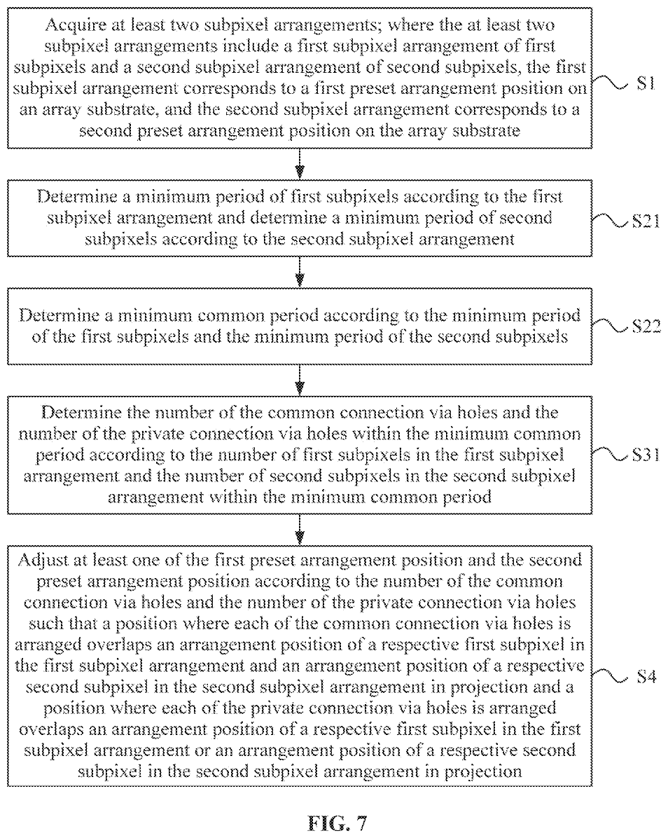

FIG. 7 is a flowchart of another method for designing an array substrate according to an embodiment of the present disclosure. Referring to FIGS. 5, 6 and 7, the method for designing the array substrate includes steps described below.

In step S1, acquiring at least two subpixel arrangements; wherein the at least two subpixel arrangements include a first subpixel arrangement of first subpixels and a second subpixel arrangement of second subpixels, the first subpixel arrangement corresponds to a first preset arrangement position on the array substrate, and the second subpixel arrangement corresponds to a second preset arrangement position on the array substrate.

In step S21, determining a minimum period of the first subpixels according to the first subpixel arrangement and determining a minimum period of the second subpixels according to the second subpixel arrangement.

Exemplarily, the first subpixel arrangement is a n-type arrangement and forms a first subpixel arrangement pattern shown in FIG. 1. The minimum period of the first subpixels Ti includes one row and one column of (that is, one) pixel unit P. The second subpixel arrangement is a diamond-type arrangement and forms a second subpixel arrangement pattern shown in FIG. 2. The minimum period of the second subpixels T2 includes one row and two columns of (that is, two) pixel units P.

In step S22, determining the minimum common period according to the minimum period of the first subpixels and the minimum period of the second subpixels.

Optionally, the minimum period of the first subpixels T1 includes n1 rows and m1 columns of pixel units P, where the pixel units P include at least two subpixels. The minimum period of the second subpixels T2 includes n2 rows and m2 columns of pixel units P. The minimum common period T includes N rows and M columns of pixel units P, where N is a least common multiple of n1 and n2 and M is a least common multiple of m1 and m2.

Exemplarily, the minimum period of the first subpixels T1 includes one row and one column of pixel unit P and the minimum period of the second subpixels T2 includes one row and two columns of pixel units P. The minimum common period T includes one row and two columns of pixel units P.

In step S31, determining the number of the common connection via holes and the number of the private connection via holes within the minimum common period according to a number of subpixels in the first subpixel arrangement and a number of subpixels in the second subpixel arrangement within the minimum common period.

Optionally, the number of the common connection via holes H1 is smaller than or equal to a smaller one of the number of subpixels in the first subpixel arrangement and the number of subpixels in the second subpixel arrangement within the minimum common period T. The number of the private connection via holes H2 is equal to a difference between a larger one of the number of subpixels in the first subpixel arrangement and the number of subpixels in the second subpixel arrangement within the minimum common period T and the number of the common connection via holes H1.

Exemplarily, within the minimum common period T, the number of subpixels in the first subpixel arrangement is 6 and the number of subpixels in the second subpixel arrangement is 4. Therefore, four common connection via holes H1 and two private connection via holes H2 may be arranged within the minimum common period T. When the first subpixel arrangement is adopted in the array substrate, six subpixels overlap the four common connection via holes H1 and the two private connection via holes H2. When the second subpixel arrangement is adopted in the array substrate, four subpixels overlap the four common connection via holes H1.

In step S4, adjusting at least one of the first preset arrangement position and the second preset arrangement position according to the number of the common connection via holes and the number of the private connection via holes such that a position where each of the common connection via holes is arranged overlaps an arrangement position of a respective first subpixel in the first subpixel arrangement and an arrangement position of a respective second subpixel in the second subpixel arrangement in projection and a position where each of the private connection via holes is arranged overlaps an arrangement position of a respective first subpixel in the first subpixel arrangement or an arrangement position of a respective second subpixel in the second subpixel arrangement in projection.

In the embodiment of the present disclosure, the minimum period of the first subpixels T1 is determined according to the first subpixel arrangement and the minimum period of the second subpixels T2 is determined according to the second subpixel arrangement. The minimum common period is determined according to the minimum period of the first subpixels Ti and the minimum period of the second subpixels T2. Additionally, the number of the common connection via holes H1 and the number of the private connection via holes H2 within the minimum common period T are determined according to the number of subpixels in the first subpixel arrangement and the number of subpixels in the second subpixel arrangement within the minimum common period T.

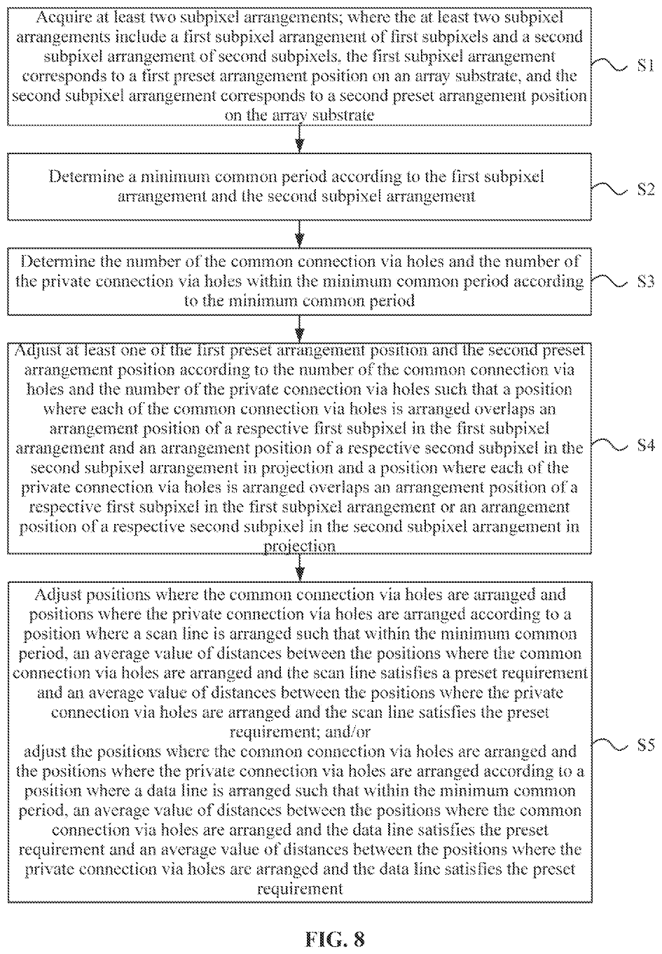

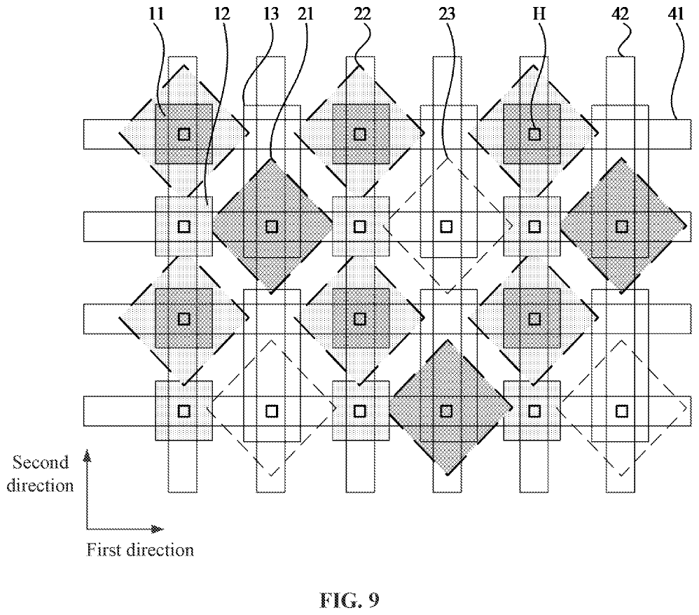

FIG. 8 is a flowchart of another method for designing an array substrate according to an embodiment of the present disclosure. FIG. 9 is a schematic diagram of another connection via holes according to an embodiment of the present disclosure. Referring to FIGS. 5, 6, 8 and 9, the method for designing the array substrate includes steps described below.

In step S1, acquiring at least two subpixel arrangements; wherein the at least two subpixel arrangements include a first subpixel arrangement of first subpixels and a second subpixel arrangement of second subpixels, the first subpixel arrangement corresponds to a first preset arrangement position on the array substrate, and the second subpixel arrangement corresponds to a second preset arrangement position on the array substrate.

In step S2, determining a minimum common period according to the first subpixel arrangement and the second subpixel arrangement, wherein the minimum common period is a minimum period of a subpixel arrangement formed by an overlap of the first subpixel arrangement and the second subpixel arrangement.

In step S3, determining a number of common connection via holes and a number of private connection via holes within the minimum common period according to the minimum common period.

In step S4, adjusting at least one of the first preset arrangement position and the second preset arrangement position according to the number of the common connection via holes and the number of the private connection via holes such that a position where each of the common connection via holes is arranged overlaps an arrangement position of a respective first subpixel in the first subpixel arrangement and an arrangement position of a respective second subpixel in the second subpixel arrangement in projection and a position where each of the private connection via holes is arranged overlaps an arrangement position of a respective first subpixel in the first subpixel arrangement or an arrangement position of a respective second subpixel in the second subpixel arrangement in projection.

In step S5, adjusting positions where the common connection via holes are arranged and positions where the private connection via holes are arranged according to a position where a respective scan line of the plurality of scan lines is arranged such that within the minimum common period, an average value of distances between the positions where the common connection via holes are arranged and the scan line satisfies a preset requirement and an average value of distances between the positions where the private connection via holes are arranged and the scan line satisfies the preset requirement; and/or adjusting the positions where the common connection via holes are arranged and the positions where the private connection via holes are arranged according to a position where a data line is arranged such that within the minimum common period, an average value of distances between the positions where the common connection via holes are arranged and the data line satisfies the preset requirement and an average value of distances between the positions where the private connection via holes are arranged and the data line satisfies the preset requirement.

Exemplarily, as shown in FIG. 9, the array substrate further includes a plurality of scan lines 41 and a plurality of data lines 42. The plurality of scan lines 41 extend along a first direction and are arranged along a second direction, and the plurality of data lines 42 extend along the second direction and are arranged along the first direction. After the positions of the common connection via holes and the positions of the private connection via holes are determined according to the number of the common connection via holes and the number of the private connection via holes, the positions where the common connection via holes H1 are arranged and the positions where the private connection via holes H2 are arranged may be further adjusted according to the position of the scan line 41 and/or the position of the data line 42 such that connection via holes H are close to the scan line 41 and/or the data line 42, and thus the array substrate has approximate electrical characteristics at the positions of the connection via holes H. Further, all the connection via holes H overlap the scan line 41 and/or all the connection via holes H overlap the data line 42, thereby further reducing a difference between the electrical characteristics of the array substrate at the positions of the connection via holes H.

Optionally, the average value of distances Dᵢ satisfies that Dᵢ<5W_{wiring}. W_{wiring} denotes a line width in the array substrate. W_{wiring} may be, for example, a width of the scan line 41 or the data line 42. In other words, the average value of the distances between the positions where the common connection via holes H1 are arranged and the scan line 41 is less than or equal to 5W_{wiring}, the average value of the distances between the positions where the private connection via holes H2 are arranged and the scan line 41 is less than or equal to 5W_{wiring}, the average value of the distances between the positions where the common connection via holes H1 are arranged and the data line 42 is less than or equal to 5W_{wiring}, and the average value of the distances between the positions where the private connection via holes H2 are arranged and the data line 42 is less than or equal to 5W_{wiring}.

In the embodiment of the present disclosure, based on the preceding embodiments, the positions where the common connection via holes H1 are arranged and the positions where the private connection via holes H2 are arranged are further adjusted according to the position of the scan line 41 and/or the position of the data line 42 such that the connection via holes H are close to the scan line 41 and/or the data line 42, and thus the array substrate has approximate electrical characteristics at the positions of the connection via holes H.

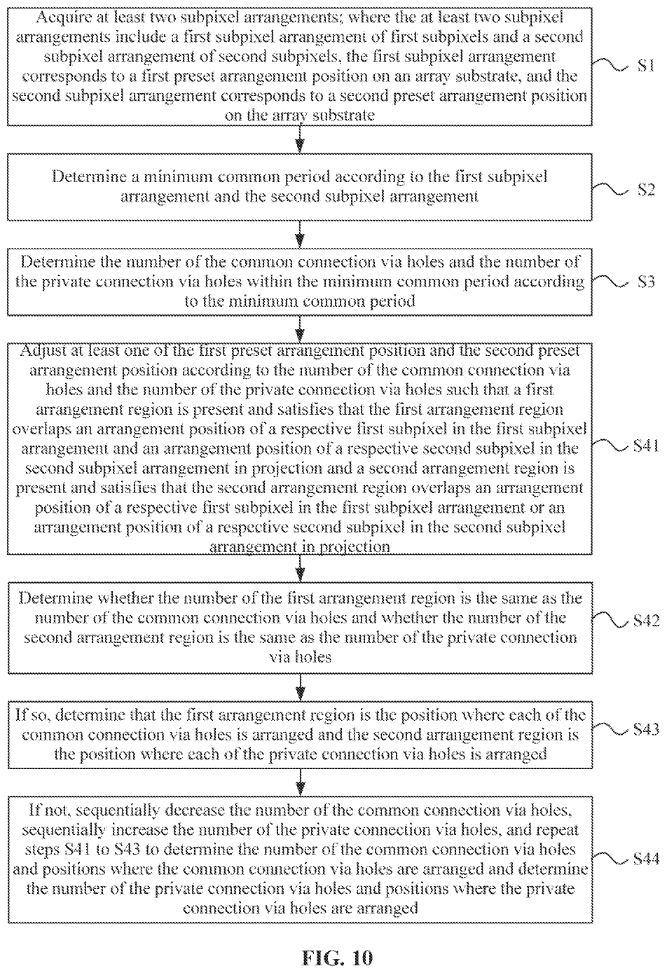

FIG. 10 is a flowchart of another method for designing an array substrate according to an embodiment of the present disclosure. Referring to FIGS. 5, 6 and 10, the method provided in the embodiment of the present disclosure includes steps described below.

In step S1, acquiring at least two subpixel arrangements; where the at least two subpixel arrangements include a first subpixel arrangement of first subpixels and a second subpixel arrangement of second subpixels, the first subpixel arrangement corresponds to a first preset arrangement position on the array substrate, and the second subpixel arrangement corresponds to a second preset arrangement position on the array substrate.

In step S2, determining a minimum common period according to the first subpixel arrangement and the second subpixel arrangement, where the minimum common period is a minimum period of a subpixel arrangement formed by an overlap of the first subpixel arrangement and the second subpixel arrangement.

In step S3, determining a number of common connection via holes and a number of private connection via holes within the minimum common period according to the minimum common period.

In step S41, adjusting at least one of the first preset arrangement position and the second preset arrangement position according to the number of the common connection via holes and the number of the private connection via holes such that a first arrangement region is present and satisfies that the first arrangement region overlaps an arrangement position of a respective first subpixel in the first subpixel arrangement and an arrangement position of a respective second subpixel in the second subpixel arrangement in projection and a second arrangement region is present and satisfies that the second arrangement region overlaps an arrangement position of a respective first subpixel in the first subpixel arrangement or an arrangement position of a respective second subpixel in the second subpixel arrangement in projection.

The first arrangement region is a region formed in such a manner that L subpixels in L subpixel arrangements are overlapped, where L≥2. Using the first subpixel arrangement and the second subpixel arrangement as an example, the first arrangement region is a region where a subpixel in the first subpixel arrangement overlaps a subpixel in the second subpixel arrangement, such as a region A in FIG. 6. In the region A, the common connection via hole H1 overlaps two subpixels and overlaps only the two subpixels. The second arrangement region is a region with only a single subpixel in the L subpixel arrangements. Using the first subpixel arrangement and the second subpixel arrangement as an example, the second arrangement region is a region with only a subpixel in the first subpixel arrangement or a subpixel in the second subpixel arrangement, such as a region B in FIG. 6. In the region B, the private connection via hole H2 overlaps one subpixel and overlaps only the one subpixel.

In step S42, determining whether a number of the first arrangement region is the same as the number of the common connection via holes and whether a number of the second arrangement region is the same as the number of the private connection via holes.

In step S43, in response to determining that the number of the first arrangement region is the same as the number of the common connection via holes and the number of the second arrangement region is the same as the number of the private connection via holes, determining that the first arrangement region is the position where each of the common connection via holes is arranged and the second arrangement region is the position where each of the private connection via holes is arranged.

In this step, one and only one common connection via hole H1 exists in the first arrangement region, and one and only one private connection via hole H2 exists in the second arrangement region.

In step S44, in response to determining that the number of the first arrangement region is different from at least one of the number of the common connection via holes and the number of the second arrangement region is different from the number of the private connection via holes, sequentially decreasing the number of the common connection via holes, sequentially increasing the number of the private connection via holes, and repeating steps S41 to S43 to determine the number of the common connection via holes and the positions where the common connection via holes are arranged and determine the number of the private connection via holes and the positions where the private connection via holes are arranged.

In this step, if the number of the first arrangement region is different from the number of the common connection via holes H1 and/or the number of the second arrangement region is different from the number of the private connection via holes H2, two or more connection via holes H are arranged for at least one subpixel or no connection via holes H are arranged for at least one subpixel. Therefore, after the number of the common connection via holes H1 is decreased and the number of the private connection via holes H2 is increased, at least one of the first preset arrangement position and the second preset arrangement position need to be readjusted and the steps S41 to S43 need to be repeatedly performed.

In the embodiment of the present disclosure, based on the preceding embodiments, it is checked whether the number of the common connection via holes and the number of the private connection via holes are provided correctly according to whether the number of the first arrangement region is the same as the number of the common connection via holes H1 and whether the number of the second arrangement region is the same as the number of the private connection via holes H2. The number of the common connection via holes and the number of the private connection via holes are adjusted when they are incorrect until the number of the common connection via holes H1 and the positions where the common connection via holes H1 are arranged are determined correctly and the number of the private connection via holes H2 and the positions where the private connection via holes H2 are arranged are determined correctly.

It is to be noted that the subpixel arrangement shown in FIG. 5 is only an example and is not to limit the present disclosure. Hereinafter, embodiments of the present disclosure provide an arrangement of the connection via holes H after another subpixel arrangements are overlapped.

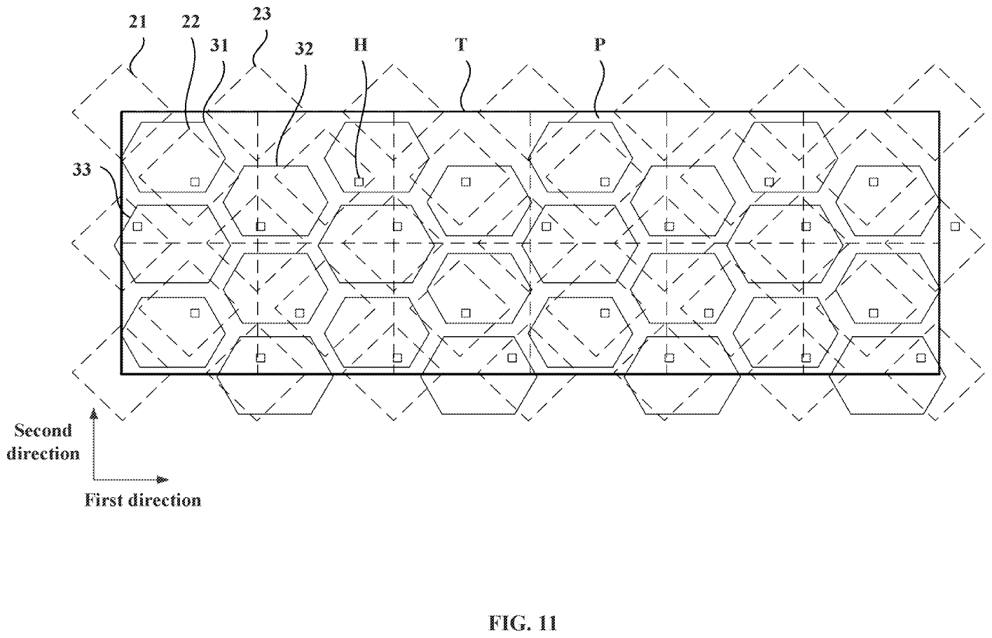

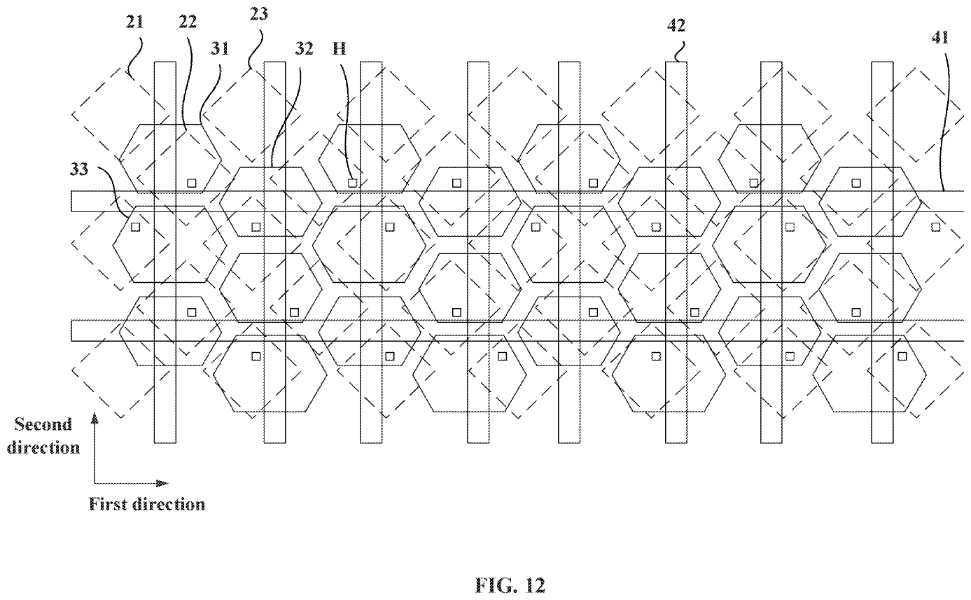

FIG. 11 is a schematic diagram of another connection via holes according to an embodiment of the present disclosure. FIG. 12 is a schematic diagram of another connection via holes according to an embodiment of the present disclosure. The subpixel arrangement shown in FIG. 12 may be considered as the subpixel arrangement shown in FIG. 2 overlapped with the subpixel arrangement shown in FIG. 3. Referring to FIGS. 2, 3, 11 and 12, the second subpixel arrangement is the diamond-type arrangement shown in FIG. 2. The third subpixel arrangement is the SPR-type arrangement shown in FIG. 3. It is to be noted that the “third subpixel arrangement” is only a reference name for clarity and is essentially one subpixel arrangement. That is, the “third subpixel arrangement” may also be referred to as the “first subpixel arrangement” or the “second subpixel arrangement”. The minimum period of the second subpixels T2 includes one row and two columns of pixel units P. The minimum period of the third subpixels T3 includes two rows and three columns of (that is, six) pixel units P. The minimum common period T includes two rows and six columns of pixel units P. Within the minimum common period T, the number of subpixels in the second subpixel arrangement is 24, and the number of subpixels in the third subpixel arrangement is 24. Therefore, within the minimum common period T, 24 common connection via holes H1 and zero private connection via holes H2 may be arranged. When the second subpixel arrangement is adopted in the array substrate, 24 subpixels overlap the 24 common connection via holes H1. When the third subpixel arrangement is adopted in the array substrate, 24 subpixels overlap the 24 common connection via holes H1.

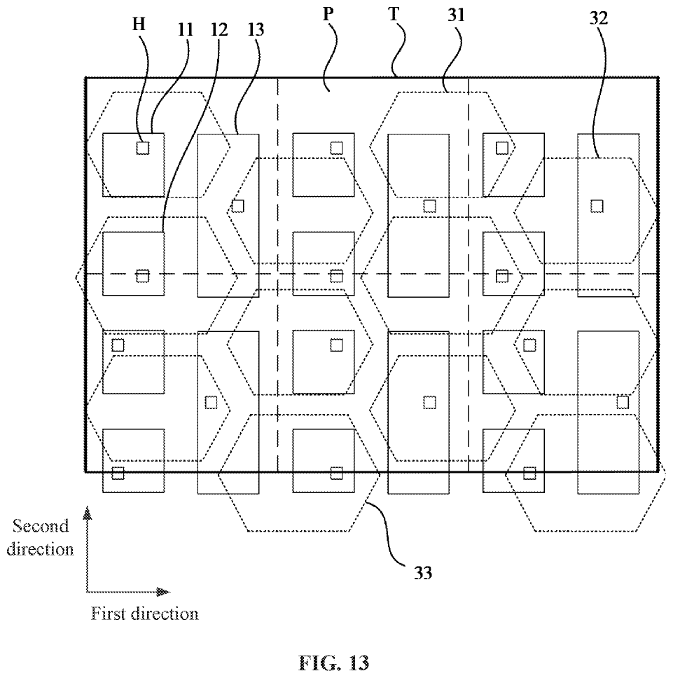

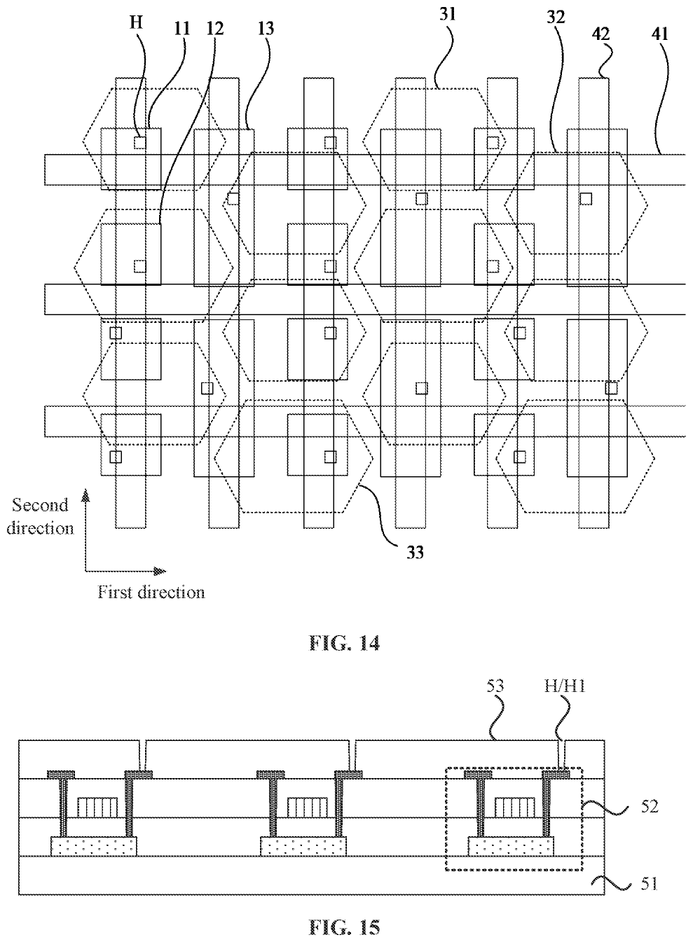

FIG. 13 is a schematic diagram of another connection via holes according to an embodiment of the present disclosure. FIG. 14 is a schematic diagram of another connection via holes according to an embodiment of the present disclosure. The subpixel arrangement shown in FIG. 13 may be considered as the subpixel arrangement shown in FIG. 1 overlapped with the subpixel arrangement shown in FIG. 3. Referring to FIGS. 1, 3, 13 and 14, the first subpixel arrangement is the π-type arrangement shown in FIG. 1. The third subpixel arrangement is the SPR-type arrangement shown in FIG. 3. The minimum period of the first subpixels T1 includes one row and one column of pixel unit P. The minimum period of the third subpixels T3 includes two rows and three columns of (that is, six) pixel units P. The minimum common period T includes two rows and three columns of pixel units P. Within the minimum common period T, the number of subpixels in the first subpixel arrangement is 18, and the number of subpixels in the third subpixel arrangement is 12. Therefore, within the minimum common period T, 12 common connection via holes H1 and 6 private connection via holes H2 may be arranged. When the first subpixel arrangement is adopted in the array substrate, 12 subpixels overlap the 12 common connection via holes H1 and 6 subpixels overlap the six private connection via holes H2. When the third subpixel arrangement is adopted in the array substrate, 12 subpixels overlap the 12 common connection via holes H1.

FIG. 15 is a schematic diagram of an array substrate according to an embodiment of the present disclosure. Referring to FIG. 15, the array substrate is designed and obtained by the preceding method. The array substrate includes a substrate 51, a drive circuit layer disposed on a side of the substrate 51 and a planarization layer 53 disposed on a side of the drive circuit layer facing away from the substrate 51. The drive circuit layer includes a plurality of drive circuits 52. The planarization layer 53 is provided with connection via holes H, where the connection via holes H at least include common connection via holes H1. The array substrate provided in the embodiment of the present disclosure is formed by the method in the preceding embodiment. Therefore, the common connection via holes H1 can be used in both a first subpixel arrangement and a second subpixel arrangement. The connection via holes H provided in the embodiment of the present disclosure are compatible with at least two subpixel arrangements. When the subpixel arrangement is switched, positions of the connection via holes formed in a previous process do not need to be modified, and a wafer does not need to be redesigned and produced, thereby reducing a material cost and time of production.

Exemplarily, referring to FIG. 15, each of the drive circuits 52 includes a thin-film transistor which includes a gate, a source, a drain and a semiconductor layer. In a direction perpendicular to the substrate 51, the connection via hole H overlaps the source or the drain of the thin-film transistor.

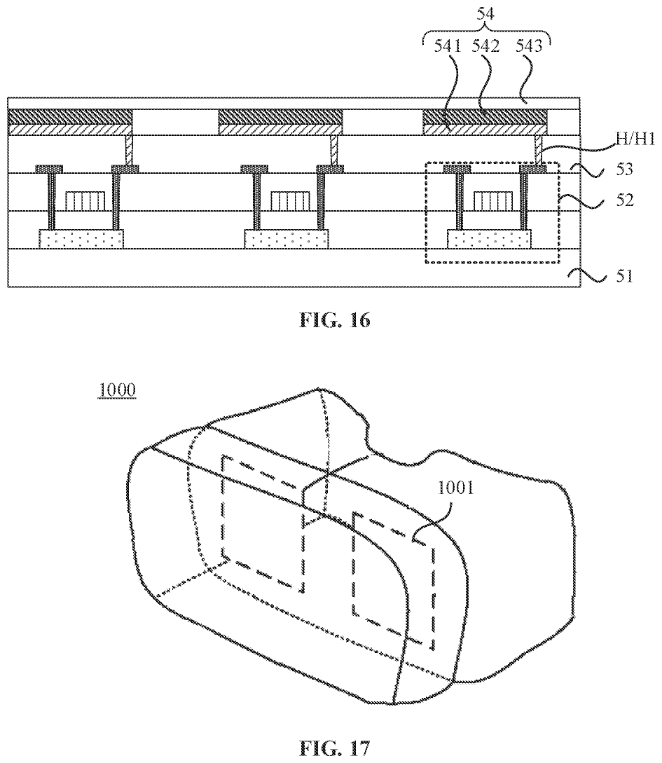

FIG. 16 is a schematic diagram of a display panel according to an embodiment of the present disclosure. Referring to FIG. 16, the display panel includes the array substrate in the preceding embodiment and further includes a plurality of subpixels 54 arranged on one side of the array substrate, where the subpixels 54 are electrically connected to drive circuits 52 through connection via holes H. The display panel provided in the embodiment of the present disclosure includes the array substrate in the preceding embodiment. Therefore, when at least two different subpixel arrangements are used, the array substrate does not need to be replaced, thereby reducing a material cost and time of production.

Exemplarily, referring to FIG. 16, each of the subpixels 54 includes an anode 541, an organic light-emitting unit 542 and a cathode 543, where the organic light-emitting unit 542 is disposed between the anode 541 and the cathode 543. A source or a drain of a thin-film transistor is electrically connected to the anode 541. The organic light-emitting unit 542 includes a light-emitting material layer and at least one of a hole injection layer, a hole transport layer, an electron blocking layer, a hole blocking layer, an electron transport layer and an electron injection layer. Light is generated in the light-emitting material layer as follows: under the action of an applied electric field, electrons and holes are injected into the light-emitting material layer from the cathode 543 and the anode 541 respectively and recombined into excitons, the excitons migrate under the action of the applied electric field, transfer energy to light-emitting molecules in the light-emitting material layer, and excite the transition of electrons from a ground state to an excited state, and energy in the excited state is released by means of radiation transition, so that light is generated. The hole injection layer, the hole transport layer, the electron blocking layer, the hole blocking layer, the electron transport layer and the electron injection layer serve as auxiliary films to improve the generation efficiency of light in a light-emitting function layer. In other embodiments, the display panel may include, for example, a liquid crystal display panel, a quantum dot display panel, an electrophoretic display panel, a micro-light-emitting diode (LED) display panel or the like.

An embodiment of the present disclosure further provides a display device. FIG. 17 is a structure diagram of a display device according to an embodiment of the present disclosure. The display device 100 provided in the embodiment of the present disclosure includes any one of the preceding display panels 1001. Since the display device adopts the preceding display panel, the display device has the same beneficial effects as the display panel in the preceding embodiment. It is to be noted that the display device provided in the embodiment of the present disclosure may further include other circuits and devices for supporting a normal operation of the display device. The display device may be one of a mobile phone, a tablet computer, an electronic paper and an electronic photo frame. The display device may also be a near-eye display device such as a virtual reality display device, an augmented reality display device, a helmet display device and smart glasses shown in FIG. 17.

It is to be noted that the above are merely preferred embodiments of the present disclosure and the principles used therein. It will be understood by those skilled in the art that the present disclosure is not limited to the embodiments described herein. Those skilled in the art can make various apparent modifications, adaptations, combinations and substitutions without departing from the scope of the present disclosure. Therefore, while the present disclosure has been described in detail through the preceding embodiments, the present disclosure is not limited to the preceding embodiments and may include more other equivalent embodiments without departing from the concept of the present disclosure. The scope of the present disclosure is determined by the scope of the appended claims.

What is claimed is:

1. A method for designing an array substrate, wherein the array substrate comprises drive circuits electrically connected to subpixels through connection via holes and configured to drive the subpixels to emit light; and the method comprises:
step S1: acquiring at least two subpixel arrangements; wherein the at least two subpixel arrangements comprise a first subpixel arrangement of first subpixels and a second subpixel arrangement of second subpixels, the first subpixel arrangement corresponds to a first preset arrangement position on the array substrate, and the second subpixel arrangement corresponds to a second preset arrangement position on the array substrate;
step S2: determining a minimum common period according to the first subpixel arrangement and the second subpixel arrangement, wherein the minimum common period is a minimum period of a subpixel arrangement formed by an overlap of the first subpixel arrangement and the second subpixel arrangement;
step S3: determining a number of common connection via holes and a number of private connection via holes within the minimum common period according to the minimum common period; and
step S4: adjusting at least one of the first preset arrangement position and the second preset arrangement position according to the number of the common connection via holes and the number of the private connection via holes such that a position where each of the common connection via holes is arranged overlaps an arrangement position of a respective first subpixel in the first subpixel arrangement and an arrangement position of a respective second subpixel in the second subpixel arrangement in projection and a position where each of the private connection via holes is arranged overlaps an arrangement position of a respective first subpixel in the first subpixel arrangement or an arrangement position of a respective second subpixel in the second subpixel arrangement in projection.

2. The method of claim 1, wherein
determining the minimum common period according to the first subpixel arrangement and the second subpixel arrangement comprises:
step S21: determining a minimum period of the first subpixels according to the first subpixel arrangement and determining a minimum period of the second subpixels according to the second subpixel arrangement; and
step S22: determining the minimum common period according to the minimum period of the first subpixels and the minimum period of the second subpixels; and
determining the number of the common connection via holes and the number of the private connection via holes within the minimum common period according to the minimum common period comprises:
step S31: determining the number of the common connection via holes and the number of the private connection via holes within the minimum common period according to a number of the first subpixels in the first subpixel arrangement and a number of the second subpixels in the second subpixel arrangement within the minimum common period.

3. The method of claim 2, wherein
the minimum period of first subpixels comprises n1 rows and m1 columns of pixel units, wherein each of the pixel units comprises at least two subpixels;
the minimum period of second subpixels comprises n2 rows and m2 columns of pixel units; and
the minimum common period comprises N rows and M columns of pixel units, wherein N is a least common multiple of n1 and n2 , and M is a least common multiple of m1 and m2.

4. The method of claim 2, wherein
the number of the common connection via holes is smaller than or equal to a smaller one of the number of the first subpixels in the first subpixel arrangement and the number of the second subpixels in the second subpixel arrangement within the minimum common period; and
the number of the private connection via holes is equal to a difference between a larger one of the number of the first subpixels in the first subpixel arrangement and the number of the second subpixels in the second subpixel arrangement within the minimum common period and the number of the common connection via holes.

5. The method of claim 1, wherein the array substrate further comprises a plurality of scan lines and a plurality of data lines; and
wherein after adjusting at least one of the first preset arrangement position and the second preset arrangement position according to the number of common connection via holes and the number of private connection via holes, the method further comprises at least one of the followings:
step S5: adjusting positions where the common connection via holes are arranged and positions where the private connection via holes are arranged according to a position where a respective scan line of the plurality of scan lines is arranged such that within the minimum common period, an average value of distances between the positions where the common connection via holes are arranged and the respective scan line satisfies a preset requirement and an average value of distances between the positions where the private connection via holes are arranged and the respective scan line satisfies the preset requirement; and
adjusting the positions where the common connection via holes are arranged and the positions where the private connection via holes are arranged according to a position where a respective data line of the plurality of data lines is arranged such that within the minimum common period, an average value of distances between the positions where the common connection via holes are arranged and the respective data line satisfies the preset requirement and an average value of distances between the positions where the private connection via holes are arranged and the respective data line satisfies the preset requirement.

6. The method of claim 5, wherein the average value of distances Dᵢ satisfies that Dᵢ≤5W_{wiring}, where W_{wiring} denotes a width of each of the plurality of data lines or a width of each of the plurality of scan lines in the array substrate.

7. The method of claim 1, wherein adjusting at least one of the first preset arrangement position and the second preset arrangement position according to the number of common connection via holes and the number of private connection via holes comprises:
step S41: adjusting at least one of the first preset arrangement position and the second preset arrangement position according to the number of the common connection via holes and the number of the private connection via holes such that a first arrangement region is present and satisfies that the first arrangement region overlaps an arrangement position of a respective first subpixel in the first subpixel arrangement and an arrangement position of a respective second subpixel in the second subpixel arrangement in projection and a second arrangement region is present and satisfies that the second arrangement region overlaps an arrangement position of a respective first subpixel in the first subpixel arrangement or an arrangement position of a respective second subpixel in the second subpixel arrangement in projection;
step S42: determining whether a number of the first arrangement region is the same as the number of the common connection via holes and whether a number of the second arrangement region is the same as the number of the private connection via holes;
step S43: in response to determining that the number of the first arrangement region is the same as the number of the common connection via holes and the number of the second arrangement region is the same as the number of the private connection via holes, determining that the first arrangement region is the position where each of the common connection via holes is arranged and the second arrangement region is the position where each of the private connection via holes is arranged; and
step S44: in response to determining that at least one of the followings is satisfied: the number of the first arrangement region is different from the number of the common connection via holes and the number of the second arrangement region is different from the number of the private connection via holes, sequentially decreasing the number of the common connection via holes, sequentially increasing the number of the private connection via holes, and repeating steps S41 to S43 to determine the number of the common connection via holes and the positions where the common connection via holes are arranged and determine the number of the private connection via holes and the positions where the private connection via holes are arranged.

8. An array substrate, wherein the array substrate is designed and obtained by the method of claim 1 and comprises:
a substrate;
a drive circuit layer disposed on a side of the substrate and comprising a plurality of drive circuits; and
a planarization layer disposed on a side of the drive circuit layer facing away from the substrate and provided with the connection via holes, wherein the connection via holes comprise at least the common connection via holes.

9. A display panel, comprising the array substrate of claim 8 and further comprising a plurality of subpixels arranged on a side of the array substrate, wherein the plurality of subpixels are electrically connected to the drive circuits through the connection via holes.

10. A display device, comprising the display panel of claim 9.
